(19) United States
(12) Patent Application Publication
(10) Pub. No.: US 2025/0065497 A1
(43) Pub. Date: Feb. 27, 2025

(54) MOVING APPARATUS, CONTROL METHOD FOR MOVING APPARATUS, ROBOT SYSTEM, MANUFACTURING METHOD FOR ARTICLE, AND STORAGE MEDIUM

(71) Applicant: CANON KABUSHIKI KAISHA, Tokyo (JP)

(72) Inventors: MICHINAO TAKAGI, Kanagawa (JP); YUKI YAMADA, Tokyo (JP)

(21) Appl. No.: 18/802,357

(22) Filed: Aug. 13, 2024

(30) Foreign Application Priority Data
Aug. 21, 2023 (JP) 2023-134169
Jun. 3, 2024 (JP) 2024-090293

(51) Int. Cl. B25J 9/16; B25J 13/08; B25J 19/00

(52) U.S. Cl. CPC B25J 9/163; B25J 9/162; B25J 9/1664; B25J 13/089; B25J 19/0004

(57) ABSTRACT

A moving apparatus on which a robot is mounted includes a unit that maintains the moving apparatus in a stopped state, wherein, based on information regarding a posture of the robot, the moving apparatus is maintained in the stopped state using the unit.

### BACKGROUND

### Field

The present disclosure relates to a moving apparatus.

### Description of the Related Art

In recent years, a robot system, in which a robot is mounted on a mobile stand, has become possible to move to a plurality of operation positions and handle a plurality of operation processes, such as a part assembly operation, a part inspection operation, and a part processing operation, thereby reducing a load on a production plant worker and reducing the number of workers. The robot system as described above is provided with a mechanism for fixing the mobile stand to reduce shifting of the mobile stand from a stop position due to an operation of the robot. According to a technique discussed in Japanese Patent Application Laid-Open No. 2000-71183, a vacuum mechanism is provided on a mobile stand to reduce position shift of the mobile stand stopped at an operation position. By reducing the positional shift of the mobile stand, it is possible to appropriately operate a robot and improve efficiency of an operation performed by the robot.

### SUMMARY

According to an aspect of the present disclosure, a moving apparatus on which a robot is mounted includes a unit configured to maintain the moving apparatus in a stopped state, wherein, based on information regarding a posture of the robot, the moving apparatus is maintained in the stopped state using the unit.

Further features of the present disclosure will become apparent from the following description of exemplary embodiments with reference to the attached drawings.

### BRIEF DESCRIPTION OF THE DRAWINGS

FIG. 1 is a perspective view of a robot system according to an exemplary embodiment.

FIG. 2 is a schematic diagram of the robot system according to the exemplary embodiment.

FIG. 3 is a control block diagram of the robot system according to the exemplary embodiment.

FIGS. 4A and 4B illustrate movements of fixing legs according to the exemplary embodiment.

FIG. 5 is a control flowchart according to the exemplary embodiment.

FIGS. 6A to 6C illustrate a predetermined posture of a robot arm according to the exemplary embodiment.

FIG. 7 is a schematic diagram of the robot system according to the exemplary embodiment.

FIGS. 8A and 8B illustrate a predetermined posture of the robot arm according to the exemplary embodiment.

FIG. 9 is a schematic diagram of the robot system according to the exemplary embodiment.

FIGS. 10A and 10B illustrate movements of the fixing legs according to the exemplary embodiment.

FIG. 11 is a schematic diagram of the robot system according to the exemplary embodiment.

FIGS. 12A and 12B are schematic diagrams of the robot system according to the exemplary embodiment.

FIGS. 13A and 13B are schematic diagrams of the robot system according to the exemplary embodiment.

FIGS. 14A and 14B are schematic diagrams of the robot system according to the exemplary embodiment.

### DESCRIPTION OF THE EMBODIMENTS

A robot system in which a robot is mounted on a mobile stand moves the mobile stand in a factory or the like to execute a plurality of operations. However, according to the technique discussed in Japanese Patent Application Laid-Open No. 2000-71183, the mobile stand on which the robot is mounted may move unstably depending on a posture of the robot at a time of moving the mobile stand, and there is a concern about falling over of the robot system.

According to the present disclosure, a possibility of a robot system in which a robot is mounted on a mobile stand falling over is reduced in a case where the robot system is moved.

Exemplary embodiments of the present disclosure will be described below with reference to the attached drawings. The exemplary embodiments described below are merely examples, and for example, detailed configurations may be appropriately modified by a person skilled in the art without departing from the spirit of the present disclosure. Further, numerical values described in the present exemplary embodiment are reference numerical values and do not limit the present disclosure. Arrows X, Y, and Z in the drawings indicate an overall coordinate system of a robot system. In general, the XYZ three-dimensional coordinate system represents a world coordinate system of an entire installation environment. In addition, a local coordinate system may be used appropriately for a robot hand, a finger, a joint, and the like for convenience of control.

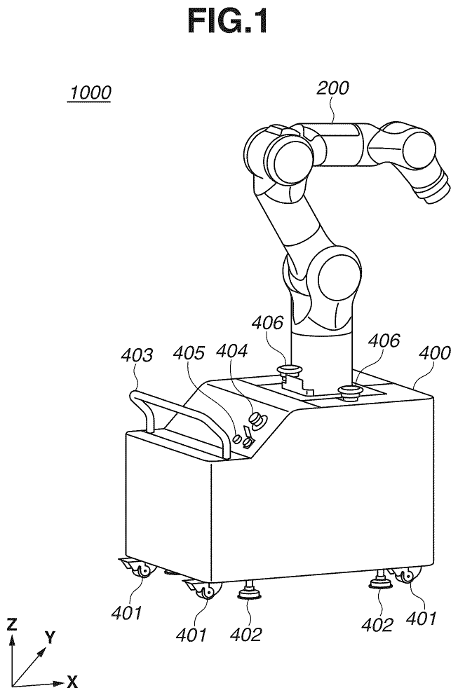

FIG. 1 is a perspective view of a mobile robot system 1000 according to a first exemplary embodiment. In FIG. 1, the robot system 1000 includes a robot arm 200 and a mobile stand 400. The mobile stand 400 may be referred to as a moving apparatus. The robot arm 200, which is an articulated robot, is mounted on an upper surface (mounting surface) of the mobile stand 400, and wheels 401 for moving the mobile stand 400 are provided on a lower surface of the mobile stand 400. A user can move the mobile stand 400 to an arbitrary position by operating a handle 403 in a state where the wheels 401 are in contact with a floor surface (or a ground surface) and thus can move the robot arm 200 to an arbitrary position. The handle 403 may be referred to as an operation unit. The handle 403 may be adjustable to a height that is convenient for a user to operate. In addition, the handle 403 may be stored in the mobile stand 400 to reduce an influence on the operation of the robot arm 200.

A plurality of fixing legs 402 is provided on the lower surface of the mobile stand 400. According to the present exemplary embodiment, four fixing legs 402 are provided. Although not illustrated in FIG. 1, two more fixing legs 402 are provided on a rear side of paper, and the fixing legs 402 have grounding portions at portions that come into contact with the floor surface.

Four wheels 401 are provided on the mobile stand 400 (one of them is on the rear side of paper in FIG. 1), and each of them is moved up and down by a mode change-over switch 405 arranged on the mobile stand 400. In a state illustrated in FIG. 1, the wheels 401 protrude from the mobile stand 400, and the fixing legs 402 are not in contact with the floor surface. Then, if the mode change-over switch 405 is pressed in the state illustrated in FIG. 1, the wheels 401 are stored in the mobile stand 400, and the grounding portions of the fixing legs 402 are brought into contact with the floor surface. In a case where the mobile stand 400 is moved, the wheels 401 are moved in a −Z direction to release contact with the floor surface of the fixing legs 402, and in a case where the mobile stand 400 is stopped at an arbitrary position, the wheels 401 are moved in a +Z direction to bring the grounding portions of the fixing legs 402 into contact with the floor surface. In this way, the mobile stand 400 can be easily released from and fixed to the ground by the mode change-over switch 405.

In FIG. 1, the mobile stand 400 is provided with area sensors 406 that recognize a surrounding environment, and if the mobile stand 400 approaches and is likely to collide with a surrounding object while moving, the area sensors 406 activate a brake (not illustrated in FIG. 1) inside the mobile stand 400 to avoid a collision. Two area sensors 406 are installed in the example in FIG. 1. In a case where the area sensors 406 detect a user nearby after the robot system 1000 is installed, an upper limit of a movement speed of the robot arm 200 is changed. Specifically, in a case where the robot arm 200 works alone, it operates at a fast speed, and in a case where it works collaboratively with a user at a close distance, it operates at a slower speed than when it works alone so as to maintain a safety-conscious speed. The mobile stand 400 is also provided with an emergency stop button 404 that immediately stops the operation of the robot arm 200 in case of abnormality.

Although not illustrated in FIG. 1, an end effector for performing an operation can be attached to a predetermined portion of the robot arm 200. Various tools such as a robot hand, a screwdriver, a cutting tool, and a polishing tool may be provided as the end effector. An electric hand and a pneumatically driven air hand may be used as the robot hand. The end effector is attached to the robot arm 200 using a semi-fixed means (not illustrated) such as a screw. Alternatively, the end effector can be attached using a detachable means (not illustrated) such as a latch (ratchet). Particularly, in a case where the end effector is detachable, a method may be considered in which the robot arm 200 is controlled to attach and detach or to replace the end effector arranged at a supply position (not illustrated) by an operation of the robot arm 200 itself.

In this way, the robot arm 200 and the end effector can be moved to a corresponding work space (a work table or a fixed stand) by the mobile stand 400, and the end effector can manufacture an article. The robot hand grasps an object, assembles it to another object, or disassembles an assembled article, tightens a screw using a screwdriver, performs cutting and polishing using a tool, and thus manufactures an article.

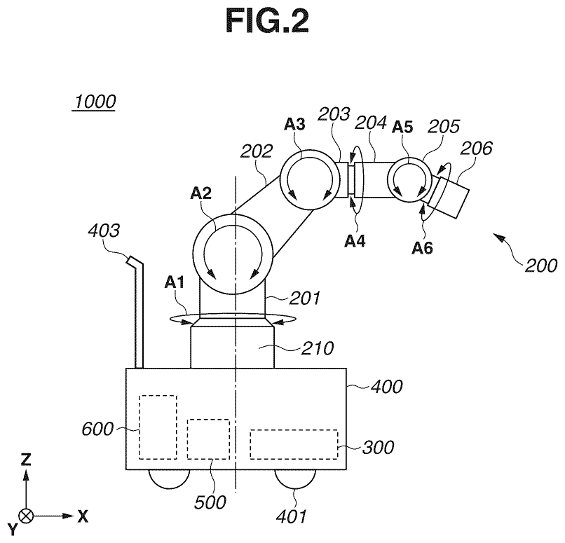

FIG. 2 is a schematic diagram of the robot system 1000 according to the present exemplary embodiment in an XZ plane. A robot control apparatus 300, a programmable logic controller (PLC) 500, and an uninterruptible power-supply system 600 are arranged inside the mobile stand 400. The robot control apparatus 300 is connected to a driving apparatus (not illustrated) installed on each shaft of the robot arm 200 via a power cable, a communication cable, or the like and controls the driving apparatus to rotatably drive each joint. Each shaft also includes an encoder (not illustrated) that detects a relative movement amount of a structure, and an operation of the robot arm 200 can be controlled by controlling a rotation direction and a rotation amount of the joint.

Although not illustrated in FIG. 2, the robot control apparatus 300 may be provided with an external input device (not illustrated) as a teaching device that transmits teaching data thereto. An example of the external input device includes a teaching pendant, which is used by a user to specify a position and a posture of the robot arm 200 and a position and a posture of the end effector. The external input device as described above may be mounted on the mobile stand 400 to be movable.

In FIG. 2, the robot arm 200 according to the present exemplary embodiment has a six-axis articulated configuration. The robot arm 200 includes a base 210 and six links 201, 202, 203, 204, 205, and 206. The links 201 to 206 are respectively rotationally driven by six driving apparatuses (not illustrated) that rotationally drive them around arrows illustrated on joint shafts A1, A2, A3, A4, A5, and A6. Each of the driving apparatuses (not illustrated) includes a motor and a reducer, which reduces an output of the motor. According to the present exemplary embodiment, a strain wave gearing reducer is used. In other words, the motor provided in the driving apparatus (not illustrated) serves as a drive source that generates a drive force for displacing each of the links 201 to 206 connected to each joint. Further, each motor includes a built-in encoder (not illustrated) that detects a rotation angle of the motor itself.

With the above-described configuration, the robot arm 200 can move the end effector to an arbitrary position to perform a predetermined operation. For example, the robot arm 200 can perform processing for assembling a predetermined workpiece and another workpiece using these workpieces as materials and thus manufacture an assembled workpiece as a final product. In addition, the robot arm 200 may perform disassemble by removing one of workpieces from a state where a predetermined workpiece is assembled with another workpiece. In this way, the robot system 1000 can manufacture an article.

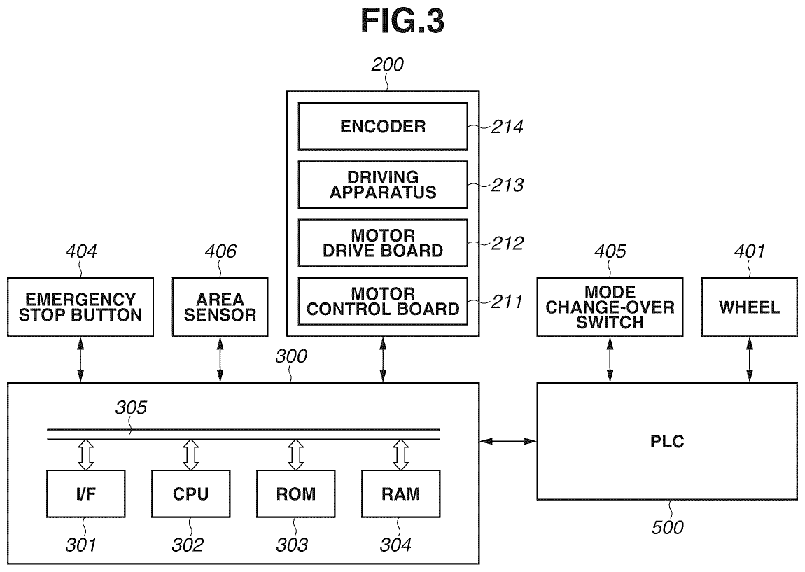

FIG. 3 is a control block diagram of the robot system 1000 according to the present exemplary embodiment. The robot control apparatus 300 is configured with a computer including a microprocessor and can control the robot arm 200 and the end effector (not illustrated). The computer included in the robot control apparatus 300 includes a central processing unit (CPU) 302 as illustrated in FIG. 3. The robot control apparatus 300 also includes a read only memory (ROM) 302 and a random access memory (RAM) 304. The robot control apparatus 300 further includes a communication interface (hereinbelow, referred to as I/F) 301. The CPU 302, which is as a processor, is an example of a control unit.

The ROM 303 stores a program. The program is a program for causing the computer, that is, the CPU 302 to execute a method for controlling the robot arm 200 and the end effector. The RAM 304 is used to temporarily store teaching data input from the external input device (not illustrated), data of a control command, and data from the PLC 500. The CPU 302 acquires data transmitted from the external input device, data from various sensors mounted on the robot arm 200, the end effector, and the mobile stand 400, data from the PLC 500, and an instruction from the emergency stop button 404 by receiving them via the I/F 301.

The robot control apparatus 300 is daisy chained to a motor control board 211 provided in each joint via a communication cable. The robot control apparatus 300 transmits a command to the motor control board 211, so that the motor control board 211 performs distributed control for controlling each motor of each driving apparatus 213 using a motor drive board 212. The robot control apparatus 300 acquires (calculates) a trajectory of the robot arm 200 to realize an operation instructed from the external input device (not illustrated). The robot control apparatus 300 transmits to each motor control board 211 various commands such as an operation command (specifically, a position command) to instruct each rotary motor to operate based on the trajectory calculation result, an operation execution start command to instruct a start of the operation based on the operation command, and a synchronization command. The ROM 303 of the robot control apparatus 300 stores a weight of each of the links 201 to 206. Then, the CPU 302 acquires (calculates) a centroid position of the robot arm 200 based on the posture of the robot arm 200 and a centroid position of each of the links 201 to 206 from an encoder 214 of each shaft.

If a user presses the emergency stop button 404, the CPU 302 transmits a command to stop the robot arm 200 to each motor control board 211 and activates a brake (not illustrated) provided in each joint. In a case where the area sensor 406 detects a presence of a user, the CPU 302 transmits to each motor control board 211 a range of speed for operating each joint and controls the driving apparatus 213 at a speed within the transmitted range. In a case where the area sensor 406 detects a possibility of the robot system 1000 colliding with an object, the CPU 302 transmits a command to stop the robot arm 200 to each motor control board 211 and activates the brake (not illustrated) provided in each joint. In a case where data indicating that an operation process is changed is acquired from the PLC 500, the CPU 302 transmits to the motor control board 211 a command to control the robot arm 200 using teaching data corresponding to the operation process to be executed.

Similarly, the PLC 500 is configured with a computer including a microprocessor. The computer included in the PLC 500 includes a CPU, a ROM, and a RAM similar to the robot control apparatus 300. The PLC 500 further includes an I/F. The PLC 500 manages the operation process and also controls the wheels 401 of the mobile stand 400. The PLC 500 controls positions of the wheels 401 if a user presses the mode change-over switch 405. The PLC 500 also acquires information regarding a state of the robot arm 200 (an arm posture and an end effector posture) from the robot control apparatus 300.

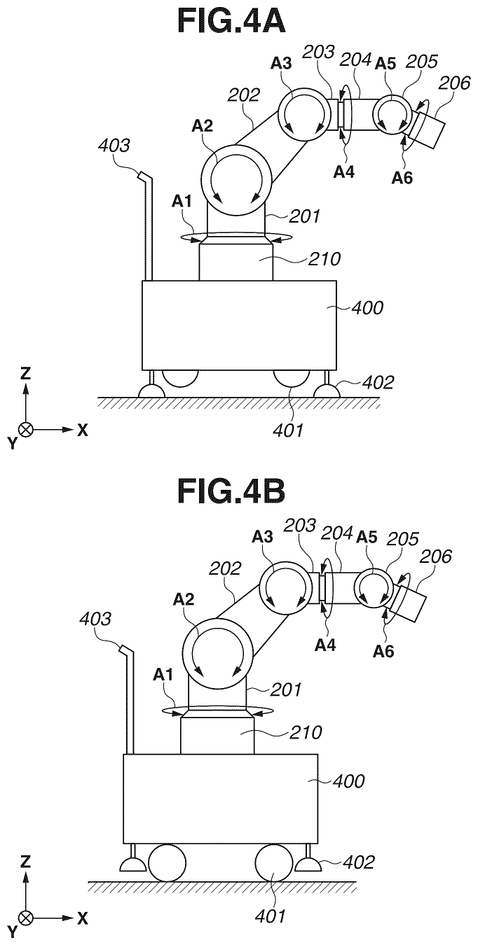

Next, a fixing method for the mobile stand 400 is described with reference to FIGS. 4A and 4B. FIG. 4A illustrates a state where the mobile stand 400 is fixed by the fixing legs 402. FIG. 4B illustrates a state where the mobile stand 400 is released from fixing by the fixing legs 402.

In FIGS. 4A and 4B, the fixing legs 402 are provided on the lower surface of the mobile stand 400, and the wheels 401 are configured to be elevated or lowered if the PLC 500 detects a switch of the mode by pressing the mode change-over switch 405. In the state in FIG. 4A, the wheels 401 are elevated, and the fixing legs 402 are in contact with the floor surface, so that the mobile stand 400 is stopped.

If the mode is switched from the state illustrated in FIG. 4A by pressing the mode change-over switch 405, the wheels 401 are lowered and lift up the mobile stand 400 on which the robot arm 200 is mounted, so that the fixing legs 402 are separated from the floor surface, and the mobile stand 400 becomes movable. If the mode is switched from the state illustrated in FIG. 4B by pressing the mode change-over switch 405, the state is changed to that illustrated in FIG. 4A, the fixing legs 402 come into contact with the floor surface, and the mobile stand 400 is stopped.

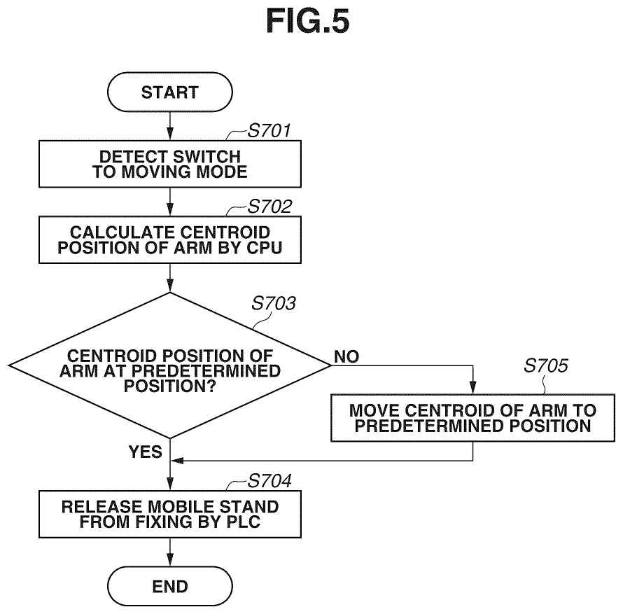

Next, conveyance control of the mobile stand 400 according to the present exemplary embodiment is described with reference to FIG. 5. FIG. 5 is a control flowchart illustrating conveyance control of the mobile stand 400 according to the present exemplary embodiment. Processing procedures described below are executed by the CPU 302 of the robot control apparatus 300 and/or the CPU of the PLC 500.

First, step S701 is processing for detecting whether a user presses the mode change-over switch 405, and the mode is switched to that for moving the mobile stand 400. In step S701, if it is detected that the mode change-over switch 405 is pressed and the mode is switched to that for moving the mobile stand 400, the processing proceeds to step S702.

Step S702 is processing in which the CPU 302 acquires (calculates) the centroid position of the robot arm 200. The processing may be processing for acquiring (calculating) the posture of the robot arm 200.

Next, step S703 is processing for determining whether the centroid position of the robot arm 200 acquired in step S702 is at a predetermined position. The processing may be processing for determining whether the posture of the robot arm 200 acquired in step S702 is a predetermined posture. The predetermined position and predetermined posture described here are a position or a posture at which the robot arm 200 is stable so that a possibility of the robot system 1000 falling over is reduced in a case where the robot arm 200 is moved on the mobile stand 400. If it is determined to be YES in step S703, the processing proceeds to step S704. If it is determined to be NO in step S703, the processing proceeds to step S705.

In a case where it is determined to be NO in step S703 and the processing proceeds to step S705, in step S705, the centroid of the robot arm 200 is moved to the predetermined position. The processing may be processing for moving the posture of the robot arm 200 to the predetermined posture.

In a case where it is determined to be YES in step S703 and the processing proceeds to step S704, or the processing proceeds to step S704 via step S705, in step S704, the CPU of the PLC 500 releases the mobile stand 400 from fixing.

In this way, the mobile stand 400 can be moved in a stable state, so that a possibility of the mobile stand 400 and the robot arm 200 falling over can be reduced in a case where the mobile stand 400 is moved.

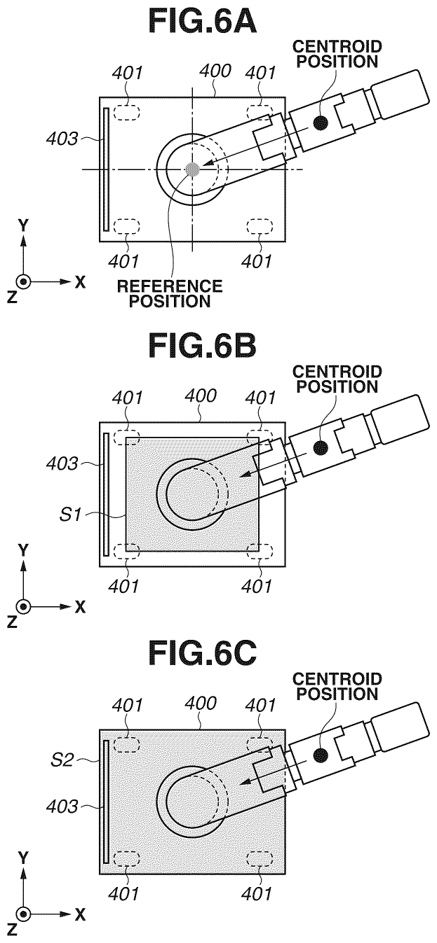

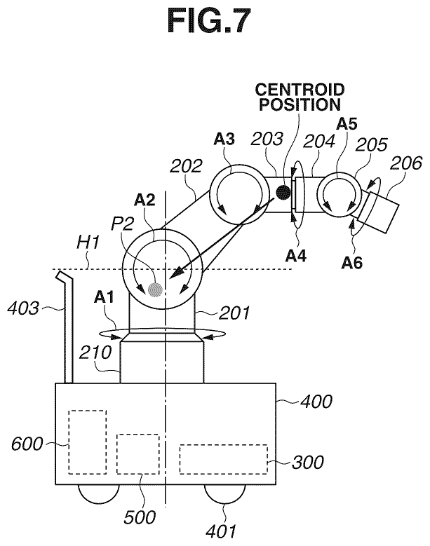

Next, the centroid position of the robot arm 200 that is a fixing release condition of the mobile stand 400 according to the present exemplary embodiment is described with reference to FIGS. 6A to 6C and 7. FIGS. 6A to 6C are top views (XY plan views) of the mobile stand 400 having four wheels 401. FIGS. 6A to 6C illustrate states where the robot arm 200 is extended, and the centroid position is at a tip side of the robot arm 200. FIG. 7 illustrates a state where a height of the centroid position of the robot arm 200 is above a height of the handle 403. In other words, it is a state where the centroid position of the robot arm 200 is located at a position higher than a portion of the handle 403 where a user touches.

FIG. 6A illustrates the centroid position of the robot arm 200 and a reference position of the mobile stand 400. The reference position in FIG. 6A is the centroid position of the mobile stand 400. In FIG. 6A, the posture of the robot arm 200 is moved to a posture in which the centroid position of the robot arm 200 is moved on or near an extension line in a Z-axis direction of the reference position of the mobile stand 400, and thus the mobile stand 400 is released from fixing. The Z-axis direction is a direction parallel to the direction of gravity of the robot arm 200 or the mobile stand 400. In this case, the height of the centroid position of the robot arm 200 does not need to be included in the fixing release condition. The centroid position of the robot arm 200 is moved to a position on or near the extension line in the Z-axis direction of the reference position of the mobile stand 400, and each joint of the robot arm 200 is folded, so that the centroid of the robot system 1000 can be stabilized. Accordingly, it is possible to reduce a possibility of the mobile stand 400 falling over in a case where it is moved and conveyed and to reduce a possibility of the robot arm 200 coming into contact with a surrounding object such as a wall or a production apparatus.

FIG. 6B illustrates the centroid position of the robot arm 200 and an area S1. The posture of the robot arm 200 is moved to a posture in which the centroid position of the robot arm 200 is moved to a predetermined region extending in the Z-axis direction of the area S1 partitioned with four wheels 401 provided on the mobile stand 400, and thus the mobile stand 400 is released from fixing. The Z-axis direction is a direction parallel to the direction of gravity of the robot arm 200 or the mobile stand 400. In the example in FIG. 6B, the area S1 is partitioned with centers of the wheels 401, but the partition is not limited to this. The reference position may be set for each of the wheels 401 to partition the area S1. In this case, the height of the centroid position of the robot arm 200 does not need to be included in the fixing release condition. The centroid position of the robot arm 200 is moved to the predetermined region extending in the Z-axis direction of the area S1 on the mobile stand 400, and each joint of the robot arm 200 is folded, so that the centroid of the robot system 1000 can be stabilized. Accordingly, it is possible to reduce a possibility of the mobile stand 400 falling over in a case where it is moved and conveyed and to reduce a possibility of the robot arm 200 coming into contact with a surrounding object such as a wall or a production apparatus.

FIG. 6C illustrates the centroid position of the robot arm 200 and an area S2. In FIG. 6C, the posture of the robot arm 200 is moved to a posture in which the centroid position of the robot arm 200 is moved to a predetermined region extending in the Z-axis direction of the area S2 partitioned with four sides of the mobile stand 400, and thus the mobile stand 400 is released from fixing. The Z-axis direction is a direction parallel to the direction of gravity of the robot arm 200 or the mobile stand 400. In other words, the area S2 is an area partitioned with the mounting surface of the robot arm 200 on the mobile stand 400. In this case, the height of the centroid position of the robot arm 200 does not need to be included in the fixing release condition. The centroid position of the robot arm 200 is moved to the predetermined region extending in the Z-axis direction of the area S2 on the mobile stand 400, and each joint of the robot arm 200 is folded, so that the centroid of the robot system 1000 can be stabilized. Accordingly, it is possible to reduce a possibility of the mobile stand 400 falling over in a case where it is moved and conveyed and to reduce a possibility of the robot arm 200 coming into contact with a surrounding object such as a wall or a production apparatus.

As illustrated in FIGS. 6B and 6C, if the area as the fixing release condition is set wider, an amount of movement of the robot arm 200 can be reduced. Even if a low-capacity power supply such as a capacitor power supply (not illustrated) that is implemented in the uninterruptible power-supply system 600 and the robot control apparatus 300 and stores regenerative power is used, the posture of the robot arm 200 can be set to a posture that stabilizes the robot system 1000.

FIG. 7 illustrates the centroid position of the robot arm 200 and a height H1 of the handle 403. In FIG. 7, the posture of the robot arm 200 is changed so that the height of the centroid position of the robot arm 200 is lower than the height H1 of the handle 403, and then the mobile stand 400 is released from fixing. In other words, the posture of the robot arm 200 is changed so that the centroid position of the robot arm 200 is located at a position lower than the portion of the handle 403 where a user touches. In addition, the centroid position of the robot arm 200 may be moved to the above-described areas S1 and S2 to release fixing. For example, in a case where the centroid position of the robot arm 200 is on the tip side and is higher than the height H1 of the handle 403, the centroid position is moved to a position P2, which is lower than the handle 403, and then the mobile stand 400 is released from fixing and becomes movable. Depending on circumstances, if the stability of the robot system 1000 can be ensured even if the centroid position of the robot arm 200 is not moved to the area S1, the area S2, or the reference position, the mobile stand 400 may be released from fixing by moving the centroid position of the robot arm 200 to the position P2.

According to the present exemplary embodiment as described above, in a case where the posture of the robot arm 200 mounted on the mobile stand 400 is not a predetermined stable posture, the mobile stand 400 is maintained in the fixed state (stopped state) even if a user attempts to move the mobile stand 400. Then, if the posture of the robot arm 200 mounted on the mobile stand 400 becomes the predetermined posture, the mobile stand 400 is released from fixing. Accordingly, in a case where the robot system in which the robot is mounted on the mobile stand is moved, a possibility of the robot and the mobile stand falling over can be reduced. In addition, the present exemplary embodiment may be implemented by being combined with various exemplary embodiments and modifications described below.

The exemplary embodiment is described above taking a case where the mobile stand 400 includes four wheels 401 as an example, but the present disclosure is not limited to this. According to a second exemplary embodiment, a configuration is described in which the mobile stand 400 includes three wheels 401. In the following descriptions, configurations that are the same as or equivalent to those according to the above-described exemplary embodiment are denoted by the same reference numerals, and their descriptions are omitted or simplified. Points that are different from the above-described exemplary embodiment are mainly described.

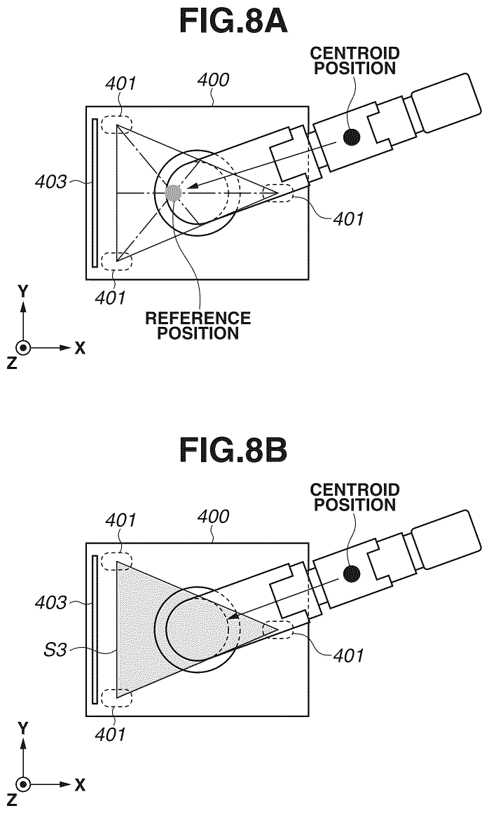

FIGS. 8A and 8B are top views (XY plan views) of the mobile stand 400 according to the present exemplary embodiment that includes three wheels 401. FIG. 8A illustrates the centroid position of the robot arm 200 and the reference position of the mobile stand 400. In FIG. 8A, the reference position is set in a predetermined region extending in the Z-axis direction of a triangle partitioned with three wheels 401 included in the mobile stand 400.

The Z-axis direction is a direction parallel to the direction of gravity of the robot arm 200 or the mobile stand 400.

In FIG. 8A, the posture of the robot arm 200 is moved to a posture in which the centroid position of the robot arm 200 is moved on or near the extension line in the Z-axis direction of the reference position of the mobile stand 400, and thus the mobile stand 400 is released from fixing. In this case, the height of the centroid position of the robot arm 200 does not need to be included in the fixing release condition. The centroid position of the robot arm 200 is moved to a position on or near the extension line in the Z-axis direction of the reference position of the mobile stand 400, and each joint of the robot arm 200 is folded, so that the centroid of the robot system 1000 can be stabilized. Accordingly, it is possible to reduce a possibility of the mobile stand 400 falling over in a case where it is moved and conveyed and to reduce a possibility of the robot arm 200 coming into contact with a surrounding object such as a wall or a production apparatus.

FIG. 8B illustrates the centroid position of the robot arm 200 and an area S3. The posture of the robot arm 200 is moved to a posture in which the centroid position of the robot arm 200 is moved to a predetermined region extending in the Z-axis direction of the area S3 partitioned with three wheels 401 provided on the mobile stand 400, and thus the mobile stand 400 is released from fixing. In the example in FIG. 8B, the area S3 is partitioned with the centers of the wheels 401, but the partition is not limited to this. The reference position may be set for each of the wheels 401 to partition the area S3. In this case, the height of the centroid position of the robot arm 200 does not need to be included in the fixing release condition. The centroid position of the robot arm 200 is moved to the predetermined region extending in the Z-axis direction of the area S3 on the mobile stand 400, and each joint of the robot arm 200 is folded, so that the centroid of the robot system 1000 can be stabilized. Accordingly, it is possible to reduce a possibility of the mobile stand 400 falling over in a case where it is moved and conveyed and to reduce a possibility of the robot arm 200 coming into contact with a surrounding object such as a wall or a production apparatus.

According to the present exemplary embodiment as described above, in a case where the posture of the robot arm 200 mounted on the mobile stand 400 is not a predetermined stable posture, the mobile stand 400 is maintained in the fixed state even if a user attempts to move the mobile stand 400. Then, if the posture of the robot arm 200 mounted on the mobile stand 400 becomes the predetermined posture, the mobile stand 400 is released from fixing. Accordingly, in a case where the robot system in which the robot is mounted on the mobile stand is moved, a possibility of the robot and the mobile stand falling over can be reduced even if the wheels 401 of the mobile stand 400 are three. In addition, the present exemplary embodiment may be implemented by being combined with the various exemplary embodiments and modifications described above.

According to a third exemplary embodiment, a configuration is described using an example in which an end effector 207 is mounted on the robot arm 200 mounted on the mobile stand 400. In the following descriptions, configurations that are the same as or equivalent to those according to the above-described exemplary embodiments are denoted by the same reference numerals, and their descriptions are omitted or simplified. Points that are different from the above-described exemplary embodiments are mainly described.

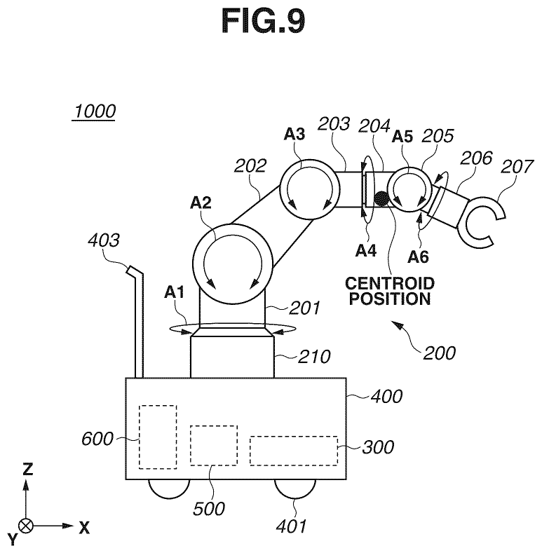

FIG. 9 is a schematic diagram of the robot system 1000 according to the present exemplary embodiment in the XZ plane. In FIG. 9, the end effector 207 is attached to the link 206 (the tip) of the robot arm 200. In a case where the end effector 207 is attached to the robot arm 200, the robot control apparatus 300 detects the attachment of the end effector 207 via the communication cable of the motor control board 211 arranged in each joint.

The end effector 207 is assigned an identification ID for each type, and the robot control apparatus 300 receives the identification ID at a timing of detecting the attachment of the end effector 207 and identifies the type of the end effector 207. The ROM 303 of the robot control apparatus 300 stores a type and a weight of the end effector associated with the identification ID. In a case where a user switches the mobile stand 400 to the moving mode with the end effector 207 attached, the robot control apparatus 300 acquires (calculates) the centroid position including the weight of the end effector 207 and the robot arm 200. If a new operation process and the end effector 207 will be added to the robot system 1000, the robot system 1000 can be used for the new operation process by writing information to the ROM 303 without largely changing the configuration of the mobile stand 400.

A control flowchart in a case where the end effector 207 is attached is similar to that described above with reference to FIGS. 5 and 7. In FIGS. 8A and 8B, the posture of the robot arm 200 is changed so that the height of the centroid position of the robot arm 200 including the end effector 207 is lower than the height of the handle 403, and then the mobile stand 400 is released from fixing. In addition, the centroid position of the robot arm 200 may be moved to the above-described area S1, S2, or S3 to release fixing. For example, in a case where the centroid position of the robot arm 200 is on the tip side and is higher than the height of the handle 403, the centroid position is moved to a position, which is lower than the handle 403, and then the mobile stand 400 is released from fixing and becomes movable. Further, if the stability of the robot system 1000 can be ensured even if the centroid position of the robot arm 200 is not moved to the area S1, the area S2, the area S3, or the reference position according to the above-described exemplary embodiments, the mobile stand 400 may be released from fixing by moving the centroid position of the robot arm 200 to the position lower than the handle 403.

According to the present exemplary embodiment as described above, in a case where the postures of the robot arm 200 and the end effector 207 mounted on the mobile stand 400 are not predetermined stable postures, the mobile stand 400 is maintained in the fixed state even if a user attempts to move the mobile stand 400. Then, if the postures of the robot arm 200 and the end effector 207 mounted on the mobile stand 400 become the predetermined postures, the mobile stand 400 is released from fixing. Accordingly, in a case where the robot system in which the robot is mounted on the mobile stand is moved, a possibility of the robot and the mobile stand falling over can be reduced even if the end effector 207 is attached. In addition, the present exemplary embodiment may be implemented by being combined with the various exemplary embodiments and modifications described above.

According to a fourth exemplary embodiment, a fixing unit of the mobile stand 400, which is different from the various exemplary embodiments described above, is described in detail. In the following descriptions, configurations that are the same as or equivalent to those according to the above-described exemplary embodiments are denoted by the same reference numerals, and their descriptions are omitted or simplified. Points that are different from the above-described exemplary embodiments are mainly described.

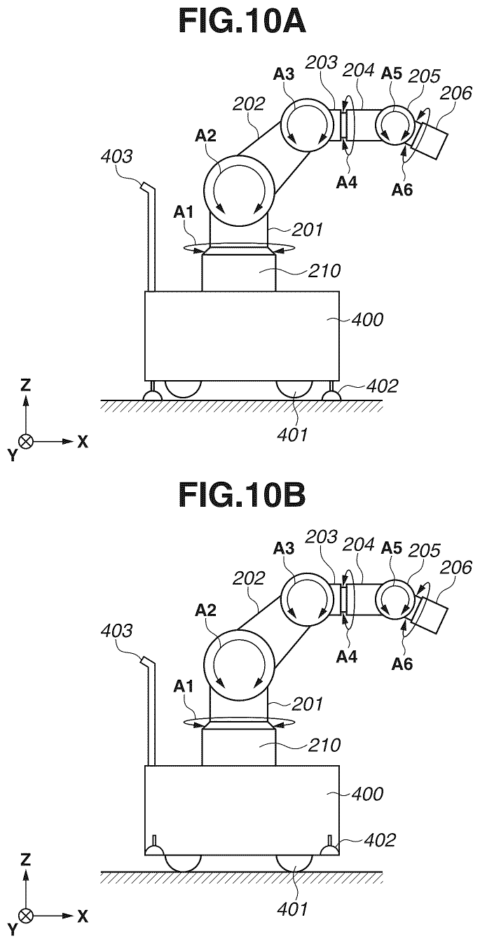

FIGS. 10A and 10B illustrate a case where the mobile stand 400 is fixed by elevating and lowering the fixing legs 402. FIG. 10A illustrates a state where the mobile stand 400 is fixed by the fixing legs 402. FIG. 10B illustrates a state where the mobile stand 400 is released from fixing by the fixing legs 402.

In FIGS. 10A and 10B, the fixing legs 402 are provided on the lower surface of the mobile stand 400 and configured to be elevated or lowered if the PLC 500 detects a switch of the mode by pressing the mode change-over switch 405. In the state illustrated in FIG. 10A, the fixing legs 402 are lowered and come into contact with the floor surface, so that the mobile stand 400 is stopped.

If the mode is switched from the state illustrated in FIG. 10A by pressing the mode change-over switch 405, the fixing legs 402 are elevated, and the wheels 401 come into contact with the floor surface, so that the mobile stand 400 becomes movable. If the mode is switched from the state illustrated in FIG. 10B by pressing the mode change-over switch 405, the state is changed to that illustrated in FIG. 10A, so that the fixing legs 402 come into contact with the floor surface, and the mobile stand 400 is stopped.

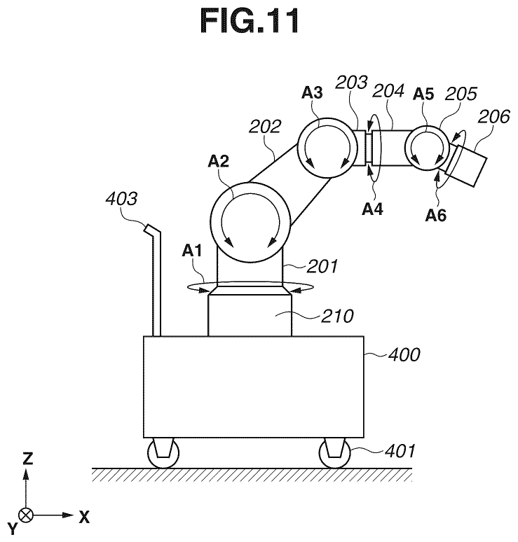

FIG. 11 illustrates a case where the wheels 401 are equipped with brakes to fix the mobile stand 400. In FIG. 11, the wheels 401 of the mobile stand 400 are equipped with the brakes, and in a case where the mode is switched to a mode for fixing the mobile stand 400 by the mode change-over switch 405, the brakes on the wheels 401 are activated, and the mobile stand 400 is fixed. In a case where a user presses the mode change-over switch 405 again, the brakes on the wheels 401 are released, and the mobile stand 400 becomes movable.

The brakes provided on the wheels 401 may be a mechanical brake such as an electromagnetic brake, a drum brake, or a disc brake. The configuration of the mobile stand 400 may include information about elevating and lowering the fixing legs 402 and the brakes on the wheels 401.

According to the present exemplary embodiment as described above, in a case where the postures of the robot arm 200 and the end effector 207 mounted on the mobile stand 400 are not predetermined stable postures, the mobile stand 400 is maintained in the fixed state even if a user attempts to move the mobile stand 400. Then, if the postures of the robot arm 200 and the end effector 207 mounted on the mobile stand 400 become the predetermined postures, the mobile stand 400 is released from fixing. Accordingly, in a case where the robot system in which the robot is mounted on the mobile stand is moved, a possibility of the robot and the mobile stand falling over can be reduced even if various fixing units are used. In addition, the present exemplary embodiment may be implemented by being combined with the various exemplary embodiments and modifications described above.

According to a fifth exemplary embodiment, another exemplary embodiment of a predetermined posture of the robot arm 200 on the mobile stand 400 is described in detail. In the following descriptions, configurations that are the same as or equivalent to those according to the above-described exemplary embodiments are denoted by the same reference numerals, and their descriptions are omitted or simplified. Points that are different from the above-described exemplary embodiments are mainly described.

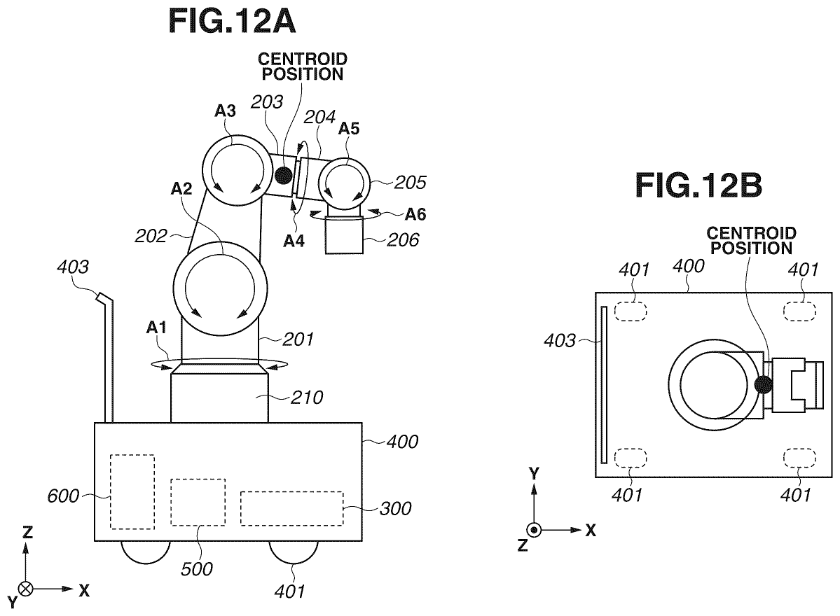

FIGS. 12A and 12B illustrate the predetermined posture of the robot arm 200 according to the present exemplary embodiment. FIGS. 12A and 12B are schematic diagrams of the robot system 1000 in the XZ plane and the XY plane, respectively. In FIGS. 12A and 12B, according to the present exemplary embodiment, the centroid position of the robot arm 200 and the entire robot arm 200 are moved to a predetermined region extending in the Z-axis direction on the upper surface of the mobile stand 400. As long as the robot arm 200 does not go outside the predetermined region extending in the Z-axis direction on the upper surface of the mobile stand 400, a rotation amount of each joint shaft may be in any state. Releasing the mobile stand 400 from fixing is similar to that according to the various exemplary embodiments described above.

According to the present exemplary embodiment as described above, in a case where the posture of the robot arm 200 mounted on the mobile stand 400 is not a predetermined stable posture, the mobile stand 400 is maintained in the fixed state (stopped state) even if a user attempts to move the mobile stand 400. Then, if the posture of the robot arm 200 mounted on the mobile stand 400 becomes the predetermined posture, the mobile stand 400 is released from fixing. Accordingly, in a case where the robot system in which the robot is mounted on the mobile stand is moved, a possibility of the robot and the mobile stand falling over can be reduced. Further, since the centroid of the robot arm 200 is located in the predetermined region extending in the Z-axis direction on the upper surface of the mobile stand 400, the stability of the entire robot system 1000 can be improved. Furthermore, since the entire robot arm 200 is located in the predetermined region extending in the Z-axis direction on the upper surface of the mobile stand 400, if the mobile stand 400 is moved, a possibility of the robot arm 200 interfering a surrounding object can also be reduced. In addition, the present exemplary embodiment may be implemented by being combined with the various exemplary embodiments and modifications described above.

According to a sixth exemplary embodiment, another exemplary embodiment of a predetermined posture of the robot arm 200 on the mobile stand 400 is described in detail. In the following descriptions, configurations that are the same as or equivalent to those according to the above-described exemplary embodiments are denoted by the same reference numerals, and their descriptions are omitted or simplified. Points that are different from the above-described exemplary embodiments are mainly described.

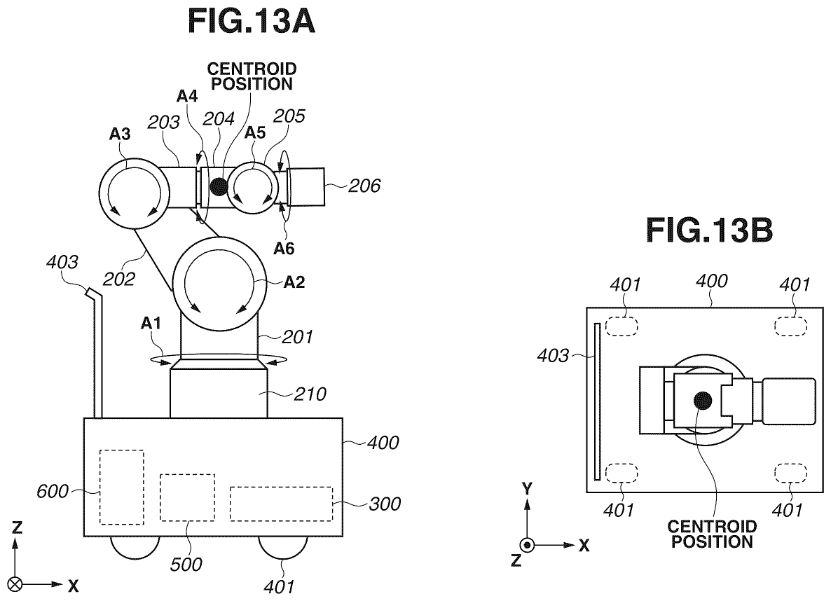

FIGS. 13A and 13B illustrate the predetermined posture of the robot arm 200 according to the present exemplary embodiment. FIGS. 13A and 13B are schematic diagrams of the robot system 1000 in the XZ plane and the XY plane, respectively. The predetermined posture illustrated in FIGS. 13A and 13B is a posture in which the centroid position of the robot arm 200 and the entire robot arm 200 are moved to a predetermined region extending in the Z-axis direction on the upper surface of the mobile stand 400, and the height of the robot arm 200 in the Z-axis direction is lowered. Among the joint shafts of the robot arm 200, the joint shafts A2 and A3 that affect the height in the Z-axis direction are operated to lower the height of the robot arm 200 in the Z-axis direction so that the handle 403 and the robot arm 200 do not interfere with each other. It is possible to further lower the centroid position by tilting the link 202 to a side opposite to the handle 403 (toward a positive X-axis direction), but it is necessary to pay attention to the centroid position so that the robot system 1000 does not fall over. Releasing the mobile stand 400 from fixing is similar to that according to the various exemplary embodiments described above.

According to the present exemplary embodiment as described above, in a case where the posture of the robot arm 200 mounted on the mobile stand 400 is not a predetermined stable posture, the mobile stand 400 is maintained in the fixed state (stopped state) even if a user attempts to move the mobile stand 400. Then, if the posture of the robot arm 200 mounted on the mobile stand 400 becomes the predetermined posture, the mobile stand 400 is released from fixing. Accordingly, in a case where the robot system in which the robot is mounted on the mobile stand is moved, a possibility of the robot and the mobile stand falling over can be reduced. Further, since the centroid of the robot arm 200 is located in the predetermined region extending in the Z-axis direction on the upper surface of the mobile stand 400, the stability of the entire robot system 1000 can be improved. Furthermore, since the entire robot arm 200 is located in the predetermined region extending in the Z-axis direction on the upper surface of the mobile stand 400, if the mobile stand 400 is moved, a possibility of the robot arm 200 interfering a surrounding object can also be reduced. Moreover, since the height of the robot arm 200 can be lowered, the stability can be further improved, and the robot arm 200 can reduce narrowing of a user's field of view and improve safety. In addition, the present exemplary embodiment may be implemented by being combined with the various exemplary embodiments and modifications described above.

According to a seventh exemplary embodiment, a state in which the robot system 1000 is provided with an input unit 700 that can be operated by a user is described in detail. In the following descriptions, configurations that are the same as or equivalent to those according to the above-described exemplary embodiments are denoted by the same reference numerals, and their descriptions are omitted or simplified. Points that are different from the above-described exemplary embodiments are mainly described.

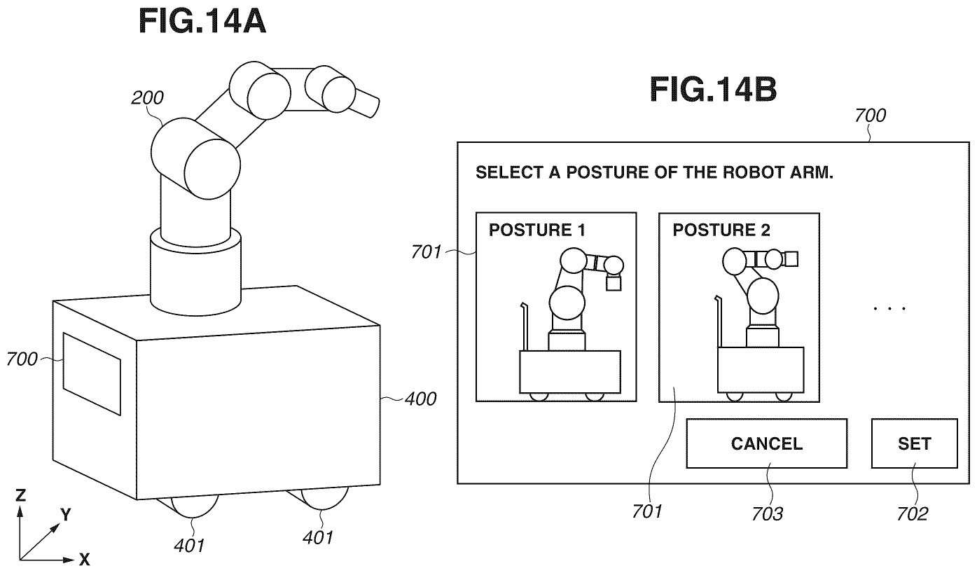

FIGS. 14A and 14B are schematic diagrams of the robot system 1000 provided with the input unit 700 that can be operated by a user. FIG. 14A is a perspective view illustrating a schematic configuration of the robot system 1000 according to the present exemplary embodiment. FIG. 14B illustrates an example of a screen, which is displayed on the input unit 700 if a user issues an instruction to release the mobile stand 400 from fixing. In FIG. 14A, some elements such as the handle 403 are omitted to simplify the description.

In FIG. 14A, according to the present exemplary embodiment, the mobile stand 400 is provided with the input unit 700 that can receive an input from a user and display information. The input unit 700 is described using a touch panel as an example but is not limited to this. The input unit 700 may be an information terminal such as a teaching pendant or a smartphone. Further, the input unit 700 may be configured to be detachable from the mobile stand 400 and may communicate with the robot control apparatus 300 or the PLC 500 via wireless or wired communication.

If a user issues an instruction to release the mobile stand 400 from fixing to move the mobile stand 400, the screen illustrated in FIG. 14B is displayed. In FIG. 14B, posture icons 701, a determination button 702, and a cancel button 703 are displayed. The posture icon 701 is an icon that displays the predetermined posture of the robot arm 200 at the time of moving the mobile stand 400 in a diagram or a model. The posture icon 701 displays the posture of the robot arm 200 that improves the stability or safety of the robot system 1000 as described above in the various exemplary embodiments. Another posture icon 701 can be displayed by sliding the posture icon 701.

Then, the user touches and selects a desired posture icon 701 and touches the determination button 702, so that the posture of the robot arm 200 is changed to that of the posture icon 701 selected by the user, and the mobile stand 400 is released from fixing. By displaying the posture of the robot arm 200 using the posture icon 701, a user can easily understand and select the posture that is desirable for the user, and convenience can be improved.

In FIG. 14B, a configuration in which the posture itself is displayed is described as an example, but the present disclosure is not limited to this. For example, each predetermined posture may be described in text and displayed in a list so that the posture can be selected. Alternatively, a physical button for executing an instruction for each predetermined posture may be provided, and text describing each predetermined posture may be provided as a label near each button. Further, in a case where only one predetermined posture is set, if a user issues an instruction to release the mobile stand 400 from fixing to move the mobile stand 400, the posture of the robot arm 200 may be automatically changed to that posture, and the mobile stand 400 may be released from fixing. Of course, even if a plurality of predetermined postures is set, one predetermined posture may be determined as a default posture, and in a case where an instruction to release the mobile stand 400 from fixing is issued, the posture of the robot arm 200 may be automatically changed to the default posture, and the mobile stand 400 may be released from fixing.

According to the present exemplary embodiment as described above, in a case where the posture of the robot arm 200 mounted on the mobile stand 400 is not a predetermined stable posture, the mobile stand 400 is maintained in the fixed state (stopped state) even if a user attempts to move the mobile stand 400. Then, if the posture of the robot arm 200 mounted on the mobile stand 400 becomes the predetermined posture, the mobile stand 400 is released from fixing. Accordingly, in a case where the robot system in which the robot is mounted on the mobile stand is moved, a possibility of the robot and the mobile stand falling over can be reduced. A user can select the posture that is desirable for the user, and convenience can be improved. Further, by displaying the posture itself, a user can easily understand and select the desirable posture, and the convenience can be improved. Furthermore, in a case where a user issues an instruction to release the mobile stand 400 from fixing, the posture of the robot arm 200 is automatically changed to the predetermined posture, so that it is possible to further improve safety and convenience for the user. In addition, the present exemplary embodiment may be implemented by being combined with the various exemplary embodiments and modifications described above.

### Other Exemplary Embodiments

Processing procedures of the above-described exemplary embodiments are specifically executed by each CPU and user inputs. Thus, it can also be configured to read and execute a storage medium storing a software program capable of executing above-described functions. In this case, the program itself read from the storage medium realizes the functions of each of the above-described exemplary embodiments, and the program itself and the storage medium storing the program configure the present disclosure.

Further, according to each of the exemplary embodiments, a case is described in which a computer-readable storage medium is a ROM, a RAM, or a flash ROM, and a control program is stored in the ROM, the RAM, or the flash ROM. However, the present disclosure is not limited to the above-described exemplary embodiments. The program for implementing the present disclosure may be stored in any computer-readable storage medium. A solid state drive (SSD) may be used as a storage unit.

According to the various exemplary embodiments described above, cases are described in which the robot arm 200 is an articulated robot arm including a plurality of joints, but the number of joints is not limited to this.

Although a vertical multi-axis configuration is described as a type of a robot arm, the same configuration as described above can be implemented with different types of joints, such as a horizontal multi-joint type, a parallel link type, and an orthogonal robot.

In a case where the height of the handle 403 mounted on the mobile stand 400 can be adjusted, the centroid position including the robot arm 200 or the end effector 207 is detected. Then, the robot system 1000 may be configured to release the mobile stand 400 from fixing by moving a grip of the handle 403 to a position higher than the detected centroid position.

According to the various exemplary embodiments described above, in a case where the robot arm 200 on the mobile stand 400 is not in the predetermined posture, the mobile stand 400 is maintained in the fixed state by the fixing unit. However, in addition to that, if a user attempts to move the mobile stand 400 in this state, a warning sound such as an alarm or a warning lamp may be emitted to notify the user to stop the movement (to issue a warning). Accordingly, it is further possible to reduce a possibility of the robot system falling over.

In defining the predetermined posture, an allowable range may be set according to specifications of the robot system. For example, in the example illustrated in FIG. 6A, an allowable width having a predetermined width may be set further around the reference position, and a predetermined region extending in the Z-axis direction may be defined as the predetermined posture.

In the example illustrated in FIG. 6B, an allowable width having a predetermined width may be set further around the area S1, and a predetermined region extending in the Z-axis direction may be defined as the predetermined posture. Further, the robot control apparatus 300 may store information regarding the predetermined posture according to the above-described various exemplary embodiments, and the predetermined posture may be selected and implemented depending on a situation.

According to the above-described exemplary embodiments, the predetermined posture is described as a stable posture of the robot arm 200 in which the robot system 1000 is less likely to fall over, but the predetermined posture may be a posture of the robot arm 200 in which the robot system 1000 is more likely to fall over. In this case, in a case where the robot arm 200 is in the predetermined posture, the mobile stand 400 is maintained in the fixed state, and in a case where the robot arm 200 is not in the predetermined posture, the mobile stand 400 is released from the fixed state.

The various exemplary embodiments described above can be applied to machines that can automatically perform movements such as extension, contraction, bending, vertical movement, horizontal movement, or rotation, or a combination of these movements based on information stored in a storage device provided in the control apparatus.

The present disclosure is not limited to the above-described exemplary embodiments and can be modified in various ways without departing from the technical idea of the present disclosure. Further, the effects described in the exemplary embodiments of the present disclosure are merely a list of the most desirable effects resulting from the present disclosure, and the effects of the present disclosure are not limited to those described in the exemplary embodiments of the present disclosure. Furthermore, the present disclosure may be implemented by combining the various exemplary embodiments and modifications described above.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-134169, filed Aug. 21, 2023, and No. 2024-090293, filed Jun. 3, 2024, which are hereby incorporated by reference herein in their entirety.

What is claimed is:

1. A moving apparatus on which a robot is mounted, the moving apparatus comprising:
a unit configured to maintain the moving apparatus in a stopped state,
wherein, based on information regarding a posture of the robot, the moving apparatus is maintained in the stopped state using the unit.

2. The moving apparatus according to claim 1, wherein, in a case where the robot is not in a predetermined posture, the moving apparatus is maintained in the stopped state using the unit.

3. The moving apparatus according to claim 2, wherein a posture different from the predetermined posture is a posture of the robot in which the robot or the moving apparatus is highly likely to fall over.

4. The moving apparatus according to claim 2, wherein, in a case where the robot is not in the predetermined posture, a notification is issued.

5. The moving apparatus according to claim 2, wherein information regarding the predetermined posture is selected, and, based on the selected information regarding the predetermined posture, the moving apparatus is maintained in the stopped state using the unit.

6. The moving apparatus according to claim 2,
wherein a user selects information regarding the predetermined posture, and
wherein a posture of the robot is changed based on the information regarding the predetermined posture selected by the user, and the moving apparatus is no longer maintained in the stopped state using the unit.

7. The moving apparatus according to claim 6, wherein the user selects the information regarding the predetermined posture via a diagram, a model, or text, or by selecting a button corresponding to the information regarding the predetermined posture.

8. The moving apparatus according to claim 2, wherein, in a case where a user issues an instruction to no longer maintain the moving apparatus in the stopped state, a posture of the robot is changed based on information regarding the predetermined posture, which is set as default, and the moving apparatus is no longer maintained in the stopped state using the unit.

9. The moving apparatus according to claim 2, wherein, in a case where the robot is not in the predetermined posture, the moving apparatus is maintained in the stopped state using the unit even if a user executes an operation of moving the moving apparatus.

10. The moving apparatus according to claim 2, wherein, in a case where the robot is not in the predetermined posture and if a user executes an operation of moving the moving apparatus, the robot is changed to the predetermined posture, and the moving apparatus is no longer maintained in the stopped state using the unit.

11. The moving apparatus according to claim 2, wherein the predetermined posture is a posture of the robot in which the robot or the moving apparatus is less likely to fall over.

12. The moving apparatus according to claim 2, wherein the predetermined posture is a posture in which the robot is located in a region obtained by extending an area partitioned with an upper surface of the moving apparatus in a direction parallel to a direction of gravity of the robot or the moving apparatus.

13. The moving apparatus according to claim 12, wherein the predetermined posture is a posture in which a height of the robot is lowered in the direction parallel to the direction of gravity of the robot or the moving apparatus.

14. The moving apparatus according to claim 2, further comprising a sensor configured to detect a state of the robot at a predetermined position,
wherein, based on the sensor, a posture in a case where the predetermined position is in a predetermined region is detected as the predetermined posture.

15. The moving apparatus according to claim 14, wherein the predetermined region is a region obtained by extending an area partitioned with wheels in a direction parallel to a direction of gravity of the robot or the moving apparatus.

16. The moving apparatus according to claim 15, wherein the predetermined region is a region extending in the direction parallel to the direction of gravity of the robot or the moving apparatus in a state where a predetermined width is set in the area.

17. The moving apparatus according to claim 14, wherein the predetermined region is a region obtained by extending an area partitioned with the moving apparatus in a direction parallel to a direction of gravity of the robot or the moving apparatus.

18. The moving apparatus according to claim 17, wherein the area is an area partitioned with a mounting surface of the robot in the moving apparatus.

19. The moving apparatus according to claim 14, wherein the predetermined region is a region obtained by extending a reference position of the moving apparatus in a direction parallel to a direction of gravity of the robot or the moving apparatus.

20. The moving apparatus according to claim 19, wherein the predetermined region is a region extending in the direction parallel to the direction of gravity of the robot or the moving apparatus in a state where a predetermined width is set at the reference position.

21. The moving apparatus according to claim 19, wherein the reference position is a centroid position of the moving apparatus.

22. The moving apparatus according to claim 14, further comprising an operation unit configured to be operated by a user,
wherein the predetermined region is a region lower than the operation unit.

23. The moving apparatus according to claim 22, wherein the predetermined region is a region lower than a portion of the operation unit touchable by a user.

24. The moving apparatus according to claim 14, wherein the predetermined position is a centroid position of the robot.

25. The moving apparatus according to claim 14, wherein the predetermined position is a centroid position of the robot and an end effector mounted on the robot.

26. The moving apparatus according to claim 1,
wherein the unit is at least one fixing leg, and
wherein the moving apparatus is maintained in the stopped state by elevating wheels included in the moving apparatus to bring the at least one fixing leg into contact with a surface.

27. The moving apparatus according to claim 1, wherein the unit is a brake provided on a wheel of the moving apparatus.

28. The moving apparatus according to claim 1, further comprising a switch configured to transition the moving apparatus from the stopped state to a state where the moving apparatus can be moved.

29. A robot system in which the robot is mounted on the moving apparatus according to claim 1.

30. A method for manufacturing an article using the robot system according to claim 29.

31. A method for controlling a moving apparatus including a unit configured to maintain the moving apparatus in a stopped state and on which a robot is mounted, the method comprising:
maintaining, based on information regarding a posture of the robot, the moving apparatus in the stopped state using the unit.

32. A non-transitory computer-readable storage medium storing a control program that causes a computer to execute the method according to claim 31.
